(19) United States
(12) Patent Application Publication
(10) Pub. No.: US 2003/0078790 A1
(43) Pub. Date: Apr. 24, 2003

(54) Method of increasing awareness of and interest in literacy by display of statue-size book replicas

(76) Inventor: David C. O'Donovan, Chicago, IL (US)

Correspondence Address: Howard B. Rockman, Lee, Mann,Smith, McWilliams Sweeney & Ohlson, P.O.Box 2786, Chicago, IL, 60690, US

(21) Appl. No.: 10/000,592

(22) Filed: Oct. 19, 2001

(51) Int. Cl. G06F 17/60

(52) U.S. Cl. 705/1

(57) ABSTRACT

A unique business method for promoting and selling books written by American authors and increasing awareness of literacy. The promotional method is designed to enhance the enthusiasm for American literature, aesthetically enhance the location surrounding the promotional books, increase tourism, create a high profile outlet for local artists and increase interaction and communication among viewing individuals. The method involves publically displaying replicas of well-known and endeared literature works by American authors. The method also involves displaying in public, statuesque copies of well-known books by American authors. Each book would be identified on the spine with its title, author and date published. The front cover of the book would be painted on the flat surface or in relief by a local artist interpreting the main theme of the book. A brief synopsis of the book would be displayed on the back cover to allow casual observers to obtain an understanding as to the content of the book. The method further involves obtaining the services of artists to decorate the books in a narrative theme taken from the subject matter of the book.

### BACKGROUND OF THE INVENTION

The present invention relates to a unique business method for promoting and selling books written by American authors and increasing awareness of and interest in literacy. The promotional method is designed to enhance the enthusiasm for American literature, aesthetically enhance the location surrounding the promotional books, increase tourism, create a high profile outlet for local artists and increasing interaction and communication among viewing individuals.

### DESCRIPTION OF THE RELATED ART

In 1988 Congress directed the Department of Education to carry out an assessment of the literacy skills of American adults. The result was the National Adult Literacy Survey (NALS), a monumental study that remains the most comprehensive, statistically reliable source of data on literacy in the United States.

The NALS found a total of 21-23 percent—or 40-44 million—of the 191 million American adults (defined as age 16 or older) at Level 1, the lowest literacy level. Although many Level 1 adults could perform many tasks involving simple texts and documents, all adults scoring at Level 1 displayed difficulty using certain reading, writing, and computational skills considered necessary for functioning in everyday life.

Nationally, fewer than 10 percent of adults who could benefit from literacy programs are currently being served. Public policies created at the state, local, and federal level do have an impact on the number of people served and the quality of programs, but fail to promote specific reading avenues directed toward increasing the awareness and enthusiasm for literature and in particular American literature.

It is therefore an object of the present invention to provide a business program that increases awareness of and enthusiasm for American literature.

It is another object of the present invention to provide a business program that is a focal point for improving literacy.

It is a further object of the present invention to increase tourism in locations in which the business program is implemented.

It is further object of the present invention to create a high profile outlet for local artists.

It is another object of the present invention to increase interaction and communication among viewing individuals.

These and other objects of the invention will become apparent after review of the specification and drawings.

### SUMMARY OF THE INVENTION

The present invention is a method of increasing awareness of and enthusiasm for literacy. The method involves publically displaying large scale replicas of well-known and endeared literature works by American authors. The approach involves displaying in public, large fiberglass replicas approximately five to seven feet in height, of well-known books by American literary authors. Each book would be identified on the spine with its title, author and date published. The front cover of the book would be painted on the flat surface or in relief by a local artist interpreting the main theme of the book. A brief synopsis of the book would be displayed on the back cover to allow casual observers to obtain an understanding as to the content of the book, and thus, an interest in obtaining and reading the book.

The books would be displayed in public places, such as in front of schools, libraries, book stores as well as public and private buildings that generate an adequate amount of traffic. Other areas would include coffee houses, museums, zoos, airports, financial districts, plazas, and shopping districts located in cities and smaller towns. The object is to place the books in locations that receive a great deal of foot traffic and would be subject to continuous observation.

The book statues are designed to create a pure aesthetic enjoyment to motivate visitors of the display to obtain copies of these works through a bookstore or from their library. The method of displaying the books would provide for an increase in awareness of and enthusiasm for American literature, would be a focal point for improving literacy by encouraging book selection contests at local schools, encouraging literary tours of the different books on display throughout a given region, and encouraging book clubs and reading groups.

The books would further create a significant tourist attraction if displayed about a certain area such as a city or town. The books would be scattered throughout an area and mapped so that tourists who possessed a map could locate and view the books in different areas of the city, taking them by other points of interest and industry.

Finally, the artwork displayed on the cover of the books as well as the synopsis located on the back cover would increase interaction and communication among casual viewers in order to increase societal interaction.

### BRIEF DESCRIPTION OF THE DRAWINGS

FIG. 1 is a perspective view of the front cover and spine of one of the book statues utilized to promote and sell books written by American authors in accordance to the present invention;

FIG. 2 is a perspective view of the rear cover and spine of the book statues utilized to promote and sell books written by American authors.

### DETAILED DESCRIPTION OF THE INVENTION

While the present invention will be described fully hereinafter with reference to the accompanying drawings, in which a particular embodiment is shown, it is to be understood at the outset that persons skilled in the art may modify the invention herein described while still achieving the desired result of this invention. Accordingly, the description with follows is to be understood as a broad informative disclosure directed to persons skilled in the appropriate arts and not as limitations of the present invention.

The present invention is a business method for promoting and selling books written by American literary authors. The marketing strategy is to create highly visible artistic masterpieces that both graphically and literally summarize and promote certain literary works by various artists and placing these items in key locations at certain time to attract people and motivate them to purchase these literary works from book sellers, for example.

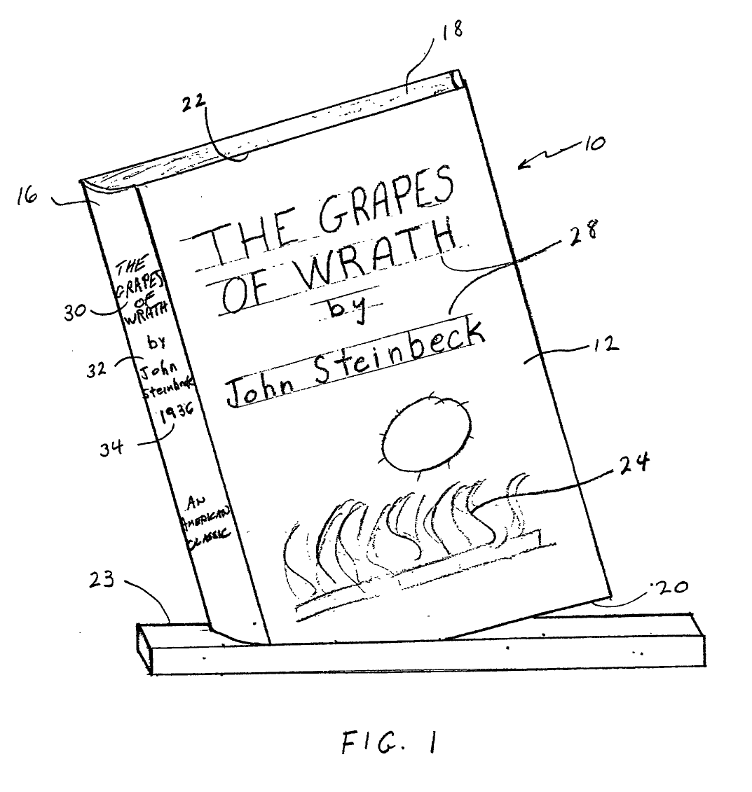

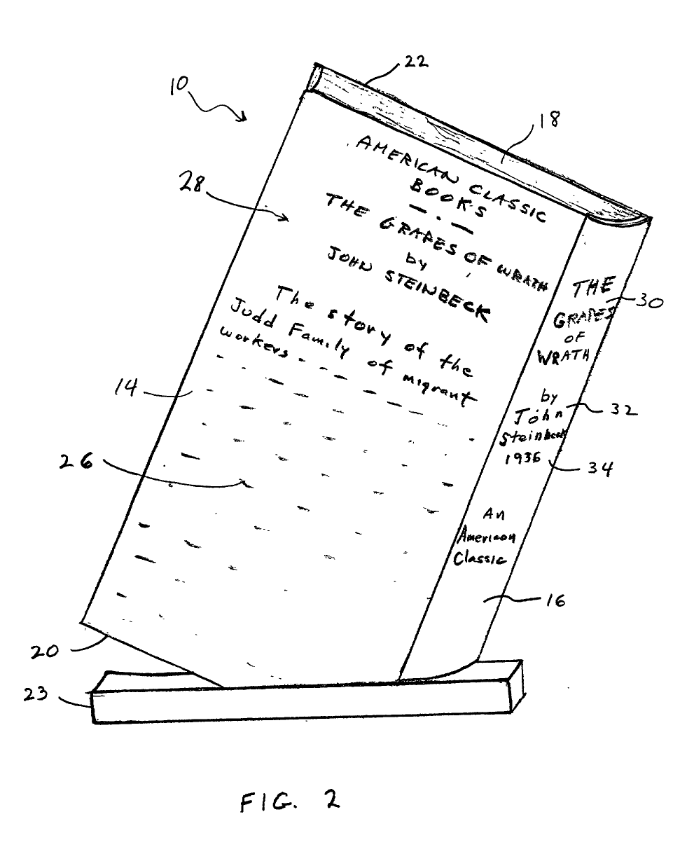

The book statues 10 utilized to promote literacy works by American authors, as shown in FIGS. 1 and 2, are fabricated out of fiberglass or other suitable material, and include a simulation of a front cover 12, a back cover 14 (FIG. 2), a spine 16 and pages 18. The book statues 10 also include a bottom side 20 and a top side 22 and are molded so that the bottom side 20 can support and maintain the upright position of the book statue 10, shown mounted at an angle in FIGS. 1 and 2 of the illustrated embodiment. If desired, the book statue 10 could also be displayed perpendicular to the ground or other support. Also, if desired, a support structure 23 is constructed beneath the book statue 10, and the book statue is suitably mounted to support structure 23. Also, if desired, bolts or other anchor elements can be used to fix support structure 23 to a base, such as a sidewalk, parking lot surface, median strip or the like.

The overall appearance of the books 10 is that of a hardcover novel or a thick paperback. The front cover 12 includes a painting 24 or graphical illustration of the main theme of a literacy work of an American author and is painted by a local artist. A desired artist would be one or more individuals that have the ability to create graphical interpretations of literary works. Graphical illustrators who are skilled in creating graphical representation of a written text may also be used. The local artists would be individuals who work and/or live in the area where the book statues 10 are displayed. If the books are displayed in a city, such as Chicago for example, artists would be invited to participate from the City of Chicago and the surrounding suburbs. The purpose of obtaining local artists is to increase interest in the community in the local arts, and aid in enhancing the reputation of the artists themselves. Use of artists to create a visual interpretation in the form of the painting 24 of the main theme of the author's works allows individuals passing the book statues 10 to be drawn to the book due to the attraction to the artwork, quickly obtain an understanding as to the theme of the book, and gain an interest in purchasing and reading the work by the author. The painting 24 or graphical illustration may be an actual painting in which acrylic or other types of paint are directly applied to the fiberglass book statue10 or may be artwork created in a studio and printed on a film that is applied to the front cover 12 of the book 10. Applying paint directly to the book 10 to create the painting 24 is preferred so that the artwork is an original work, thereby creating a perception of value by viewers.

The rear cover 14 of the book 10, shown in FIG. 2, includes a written synopsis 26 of the literary work, as well as the title and author 28 of the work. The front cover also prominently displays the title and author 28 of the work. The synopsis 26 is printed in the font type applicable to the era the American literature was created and may vary depending on the content of the novel. The synopsis 26 is drafted to capture the most entertaining and memorable portions of the literary works to captivate the reader and interest them in purchasing the works. Following the synopsis, instructions may be provided to inform interested viewers of sponsoring bookstores where the literary works can be purchased. The rear cover could also include an access panel (not shown) so that the inside surface of the bottom side 20 can be accessed to secure the book to the display location.

The spine 16 of the book 10 connects the front cover 12 to the rear cover 14 and provides identification including the title 30 of the literary work, the author 32 and the date 34 the literary work was published. The spine 16 is very visible to the observer and provides a natural transition when moving from the front cover 12 to the rear cover 14.

The pages 18 of the book 10 may be arranged so that the front cover 12 and the rear cover 14 are slightly skewed, creating the appearance that the book statue10 is partially open, and resting on the bottom side 20. While the pages 18 have the appearance of individualization, they are all interconnected during the molding process of the book statue10.

The location and placement of the book statues 10 is designed to place the book statue in an area of public view so that they can be seen by a majority of the individuals living, working and shopping in a given metropolitan area. An ideal venue for placement of the book statues 10 is during a city-wide public art exhibit, which is used by cities to increase tourism. The promotion of literacy works would be best served if the book statues 10 are placed in cultural centers, which include public libraries, learning institutions, play houses, museums and areas designed to display permanent art objects such as Picasso's work in Chicago's Daley Plaza.

Other areas of placement of the book statues 10 include business and financial districts, which includes banks, boards of trade and areas within those districts that generate high volumes of traffic. Also, public transportation routes to and from these business and financial districts. Transportation routes include ferry boarding ports, train stations, public transit stations and bus stops. Other areas targeted include metropolitan tourism centers and shopping districts. These areas draw large quantities of people which provide a large audience for view the book statues 10.

To aid in creating interest in and awareness of literature, book selection contests would be held at local high schools. The students would select the literary works that are to be displayed on the book statues 10. This allows students to become familiar with the various literary works, which would encourage reading. The student may be directed to prepare the synopsis 26 which appears on the rear of each book statue 10.

The book statue 10 would be displayed in a given time frame and placed throughout the metropolitan area. The books on display would be used for literary tours given by selected individuals. The tour guides would take the group of literary tourists to each book statue 10 and allow them to view and photograph the statues, while at the same time explaining to the tourists the subject matter, significance of the literary work and its impact on American culture.

Also, maps would be made available of the given metropolitan area with the statues marked on the maps so that individuals who are not interested in partaking on a tour can take it upon themselves to view the literary works in a preselected sequence if desired, such as chronologically.

Various features of the invention have been particularly shown and described in connection with the illustrated embodiment of the invention, however, it must be understood that these particular arrangements merely illustrate, and that the invention is to be given its fullest interpretation within the terms of the appended claims.

What is claimed is:

1. A method for promoting and selling books and creating interest in and awareness of literacy comprising the steps of:
selecting a plurality of literary works to be promoted;
providing a plurality of book statues adapted to be displayed;
obtaining the services of one or more artists to decorate said book statues in a narrative theme from subject matter of said literary works;
providing a synopsis of said literary work on an outside surface of said book statues; and
displaying said book statues in an area of public view within a single metropolitan area.

2. The method of claim 1, wherein said literary works are created by authors who lived in America.

3. The method of claim 1, comprising the additional step of placing indicia on said book statue identifying a title and an author of said literary works.

4. The method of claim 1, wherein said book statues are manufactured from plastic.

5. The method of claim 1, wherein said book statues are manufactured from fiberglass.

6. The method of claim 1, wherein said artists are selected from individuals living or working in said metropolitan area.

7. The method of claim 1, comprising the additional step of soliciting local businesses to sponsor at least one of said plurality of book statues, wherein sponsorship would include placing the name of said businesses on said book statues.

8. A method of increasing awareness of and interest in literacy comprising the steps of:
providing statues resembling books for public display;
selecting several known literary works to be displayed on said statues;
obtaining the services of at least one graphical illustrator to create a graphical representation of a narrative theme of said literary works;
applying said graphical representation to said statue, each statue containing a separate literary work;
placing indicia on said statues containing the author and title of said literary works;
placing said statues in an area of public view within a single metropolitan area.

9. The method of claim 8, comprising the additional step of providing a synopsis of said literary works on an outside surface of said statues.

10. The method of claim 8, wherein said literary works are created by authors who lived in America.

11. The method of claim 8, wherein said book statues are manufactured from plastic.

12. The method of claim 8, wherein said book statues are manufactured from fiberglass.

13. The method of claim 8, wherein said graphical illustrators are selected from individuals living or working in said metropolitan area.

14. The method of claim 8, comprising the additional step of soliciting local businesses to sponsor at least one of said plurality of book statues, wherein sponsorship would include placing the name of said businesses on said book statues.
